(19) United States
(12) Patent Application Publication
(10) Pub. No.: US 2019/0026483 A1
(43) Pub. Date: Jan. 24, 2019

(54) Proximity Protected Keyless Security System

(71) Applicant: Design SHIFT, Menlo Park, CA (US)

(72) Inventors: Olivier Boireau, San Francisco, CA (US); Daniel Nelson, San Jose, CA (US); Stefan Carpentier, San Jose, CA (US)

(73) Assignee: Design SHIFT

(21) Appl. No.: 15/652,573

(22) Filed: Jul. 18, 2017

(51) Int. Cl. G06F 21/62; G06F 21/35

(52) U.S. Cl. CPC G06F 21/6218; G06F 21/35

(57) ABSTRACT

The present disclosure provides systems and methods for wireless proximity security comprising a controller and a memory coupled to the controller, wherein in response to executing the program instructions, the controller is configured to receive a first acceleration data from a key fob, wherein the key fob is configured to generate an unlocking code for accessing a computer console, wherein the key fob includes a key fob accelerometer. The controller is further configured to receive a second acceleration data from the key fob, wherein the second acceleration data is received after a predetermined time from the receipt of the first acceleration data; and determine a distance traveled by the key fob between the time from receiving the first acceleration data and the time from receiving the second acceleration data, and if the first distance is greater than a predetermined distance, the controller disables access to the computer console.

### BACKGROUND OF THE INVENTION

The present subject matter relates generally to a keyless security system. More specifically, the present invention relates to a proximity protected keyless security system.

Keyless security systems have become increasingly popular in recent years. For all the benefits keyless systems provide, such systems are not without vulnerabilities. For example, one such vulnerability includes relay attacks. In a relay attack, communication between parties is initiated by an attacker who then relays messages between the two parties in order to obtain access to a secured area, etc.

Another similar vulnerability, replay attacks, occur when an attacker copies a stream of messages between two parties and replays the stream to one or more of the parties. Unless mitigated, the computers subject to the attack process the stream as legitimate messages, resulting in a range of bad consequences, such as redundant orders of an item being placed or access to a secure area or device being granted to unauthorized parties.

Many offices, vehicles, and electronic devices use remote keyless systems, or key fobs, for the convenience of the user while also providing secure access to a given area, device, etc. A key fob is a type of security token including hardware with built-in authentication mechanisms. Just as the keys held on an ordinary real-world key chain or fob control access to the owner's home or car, the mechanisms in the key fob control access to network services and information. Such systems operate by monitoring for a signal transmitted by the key fob. If the signal is within range of a receiver, which is attached to and secures the target of value (e.g., a work computer with sensitive information on it), the receiver unlocks the target. If an undesirable party is in range of the key fob, the undesirable party may be able to capture the signal sent by the fob and use the signal (at that time or later) to access the secured area, vehicle, computer, etc.

Accordingly, there is a need for a proximity protected keyless security system that monitors the physical location of system components relative to one another.

### BRIEF SUMMARY OF THE INVENTION

To meet the needs described above and others, the present disclosure provides a proximity protected keyless security system.

The system can include a computer console and key fob. The computer console may be any computer desktop, laptop, or mobile computing device (e.g., smartphone, tablet, etc.), or any other device which may be electronically secured. The console may also be proprietary in nature and feature other security features such as no external communication ports (e.g., no USB ports, Networking ports, etc.) to further enhance the secure nature of the system. The computer console can feature a processor, memory, and communications adapter. The key fob can also feature a processor, memory, and communications adapter. The key fob can also include an accelerometer. The accelerometer (e.g., a six-axis accelerometer in this embodiment) tracks movement of the key fob relative to the computer console. If the key fob's accelerometer detects movement beyond an acceptable, pre-defined amount while an end user is operating a computer console secured by the system, the system will terminate access. Access to the secured computer system can then only be regained when the key fob is returned to an acceptable proximity from the computer console. The measure of this proximity by the system can be continuous or restarted upon initial detection of the key fob when in acceptable proximity to the computer console.

In another example, the system may feature a computer console containing an accelerometer in addition to/or in place of the one present in the key fob. Such an implementation may be useful as a key fob is not practical or ideal for every implementation of the present system. For example, an office or lab can have the electronics (e.g., processor, memory, and communications adapter) embedded in a wall or ceiling, such that a computing console/device will only work within a predetermined area. This predetermined area may be defined by geotagging, etc. More practically speaking, a keyless security system which secures system components based off physical proximity of the components to one another would keep, for example, an employee from stealing a laptop full of trade secrets. If an employee took said laptop out of the area permitted by the system, access to the laptop could be terminated. Such removal could even trigger the computing device to erase any confidential data from the device if removed for an extended period, etc. The system can also be configured to enable a computing device to only be utilized in one location by authorized personnel. Such secure access can be established by use of both a key fob and electronics embedded in a wall, etc.

Another version of a keyless proximity security system may include a controller and a memory coupled to the controller, wherein the memory is configured to store program instructions executable by the controller, wherein in response to executing the program instructions, the controller is configured to receive a first acceleration data from a key fob, wherein the key fob is configured to generate an unlocking code for accessing a computer console, wherein the key fob includes a key fob accelerometer. The system is then configured to receive a second acceleration data from the key fob, wherein the second acceleration data is received after a predetermined time from the receipt of the first acceleration data; and then determine a distance traveled by the key fob between the time from receiving the first acceleration data and the time from receiving the second acceleration data, wherein if the first distance is greater than a predetermined distance, the controller is configured to disable access to the computer console.

The determination of distance traveled from the two acceleration data points mentioned above is due to the fact that acceleration is the second derivative of distance traveled with respect to time. In the example above, the system knows the acceleration and both the initial (zero) and final speeds of the key fob (or secured device, or both). From this time between the two data points can be deduced which then finally allows the system to determine the distance traveled by its various components. The system may constantly monitor the acceleration of its various components relative to one another along with other data points which enable the determination of the distance traveled between them.

This version of the system may set the above mentioned first distance as less than a predetermined distance, the controller is configured to automatically provide access to the computer console. This version of the system may also feature a computer console which includes a computer accelerometer, wherein the controller is configured to determine a second distance between the computer console and the key fob based on data received from the computer accelerometer and the key fob accelerometer, wherein if the second distance is greater than a predetermined distance, the controller is configured to disable access to the computer console. This second distance may also be utilized to allow the controller to automatically provide access to the computer console.

The computer console of this version of the system may be a desktop computer, mobile computing device, server, etc. The predetermined distance(s) which enable or disable access may be set at an increment (e.g., ten feet) using any system of measure capable of measuring distance. Access may be granted and terminated by deactivating a component of the computer console. Deactivation of such a component may be achieved by manipulation of one or more control busses.

A goal of the present system is to prevent relay and/or replay attacks as well as other forms of unauthorized access to secure locations, items, and data. The present invention utilizes not only a security verification token, but also a mechanism for monitoring if the token is continually present for the duration of the secure access. Such monitoring is achieved by use of an accelerometer (and potentially gyroscopes, inertial monitoring units, magnetometers, global positioning system(s), etc.) and has applications in securing homes, cars, detecting video game cheaters, and beyond.

An advantage of the present system is that the system virtually eliminates the possibility of clandestine relay or replay attacks. Given enough time and resources, any secured system can likely be accessed via unauthorized means. Replay attacks, in the context of key fobs, have become more popular in recent years since they can be carried out very stealthily. For example, it is recommended that credit cards using NFC are transported in RF shield sleeves due to the prevalence of such attacks. Typically, this type of attack is performed by placing a device that can receive and transmit radio waves within range of the target (e.g., a home, lab, car, computer, etc.). The replay attack device will detect and possibly jam any “unlock” signal sent to the target (though in some systems, a continuous “lock” signal is sent to the secured device), while placing the valid “unlock” signal (or “lock signal”) in memory for later use. Relay attacks may be carried out by use of multiple attack devices. In such a scenario one device is placed close to the key fob to capture information from it and a device is placed close to a computing device/receiver to relay the captured signal. The two or more attack devices are connected via a network to transmit the information.

In contrast, the present system takes into account more than the valid signal sent out by a key fob and also requires the physical location of the fob relative to the secured target to be within a specific area and also consistently remain within that area. For an unauthorized user, capturing such physical positioning data of the key fob relative to the secured target would require them to conspicuously expose themselves (e.g., be in the same physical location as the authorized user) in an attempt to glean such positioning data. Such a degree of difficulty in carrying out relay or replay attacks would greatly reduce popularity of these attacks. Additionally, the present system may also be configured to track location data without transmitting it between system devices, making such data impossible to capture and then spoof.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an overview diagram of an example of a proximity protected keyless security system.

FIG. 2 is a perspective view of components of an example of a proximity protected keyless security system.

FIG. 3 is a stepwise illustration of detailing the proximity protected keyless security system securing a computing device.

FIG. 4 is an overview diagram of an example of a proximity protected keyless security system in which two system components utilize an accelerometer.

### DETAILED DESCRIPTION OF THE INVENTION

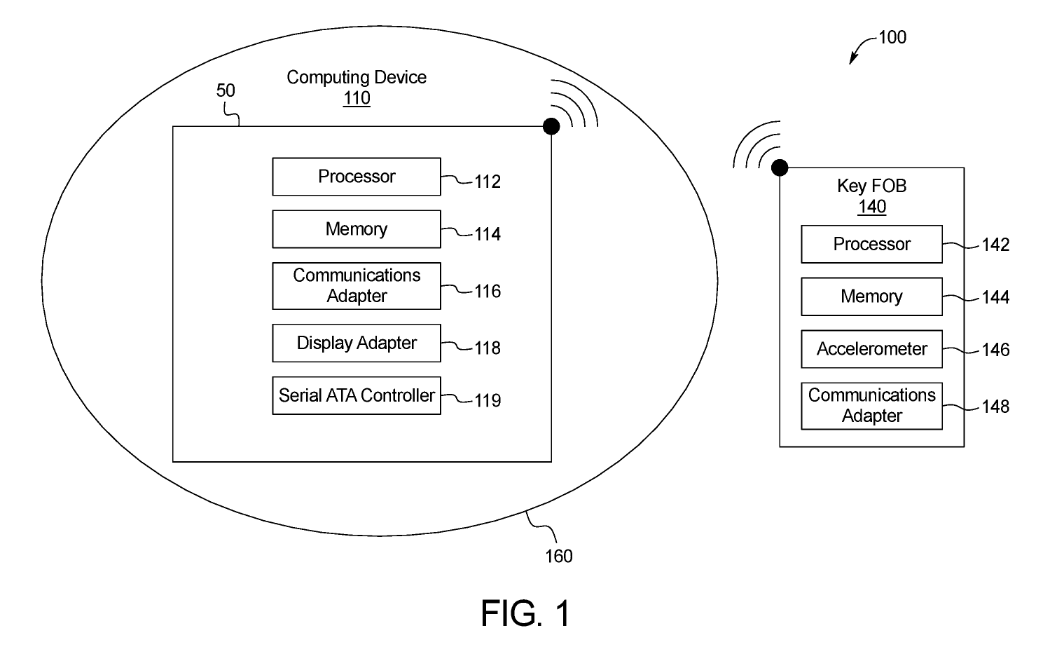

As shown in FIG. 1, a computing device 110 is secured by the proximity protected keyless security system 100. This computing device 110 may be a desktop computer, laptop, tablet, mobile device, smartphone, etc. The computing device 110 may feature a processor 112, memory 114, communications adapter 116, display adapter 118, and serial ATA controller 119. The device's 110 processor 112 can receive a signal from the communications adapter 116, wherein the signal indicates whether a key fob 140 is within a predefined distance from the device 110. If the controller determines the key fob 140 is within the predefined distance from the device 110, the controller is configured to allow access to the device 110. The communications adapter 116 may include any number of wireless communication transmitters and/or receivers for: Wi-Fi, Bluetooth, ZigBee, RF, NFC, or any other wireless communication protocol. Any of the wireless communication protocols listed above can be used by the system 100 to set a proximity field 160. A proximity field 160 is a pre-defined distance within which the key fob 140 must be present for an end user to access the system 100. Once the key fob 140 enters within a proximity field 160 (shown here as a two-dimensional oval but in actuality would likely be a three-dimensional field), the key fob 140 must remain within the proximity field 160 for the duration of an end user's access of the computing device 110.

It should be noted the proximity field 160 may be “shaped” in any manner a system 100 users wishes. For example, the proximity field 160 might be programed with a square three-dimensional shape to correspond with the physical dimensions of an office. Such a field 160 could be set up to terminate access to a secured computer system when the computer was moved outside the office (and field 160) in any direction. Additionally, the proximity field 160 might also be two-dimensional in nature, with the field resembling a level plane in line with the top of a desk or counter. If an end user was to move a secured device below the counter (e.g., out of view of a camera, for instance) access to the computer could be terminated by the system 100. The proximity field 160 may also be determined based off geographic location, GPS data, topography maps, etc.

Additionally, the proximity field 160 might only be active during certain times of day. For example, a business might set the system 100 to only be active during business hours, and once a business closes for the night, the field 160 might be deactivated by the system 100 preventing access until the business opens the next day. Such an activation or deactivation of the system 100 may be set to automatically occur ahead of time by an end user or the system 100 or even have a “kill switch” hardwired or programmed into the system 100 which enables the proximity field 160 to be terminated during an emergency.

Such physical presence of the fob 140 within the field 160 is determined by data received from an accelerometer 146 (in conjunction with a processor 142 and memory 144), wherein the accelerometer 146 is contained within key fob 140 and monitors the positional data of the key fob 140. An accelerometer 146 can be any type (e.g., a six-axis accelerometer) and the data from an accelerometer 146 may be transmitted to the computing device 110 via the key fob's 140 communication adapter 148. The key fob's 140 communications adapter 148, like the adapter 116 discussed above, may feature any number of wireless communication transmitters and/or receivers for: Wi-Fi, Bluetooth, ZigBee, RF, NFC, or any other wireless communication protocol. Alternatively, the present system 100 may not transmit the accelerometer data from the fob 140 to the computing device 110 (or vice versa) and rather the key fob 140 itself may zero the distance recorded from the fob 140 to the computing device 110 within the key fob's 140 memory 144 upon initial activation and then track movement of the key fob 140 going forward on the key fob 140 itself. Once the key fob 140 tracks movement far away enough from the initial zeroed distance recorded by the key fob 140, the fob 140 may send a “lock” signal which terminates access to the system 100.

The system 100 tracks positional data transmitted by the key fob's 140 accelerometer 146. The tracking of positional data occurs from the start of access (e.g., when the key fob 140 is within the field 160) and continues, with the system 100 tracking any changes in position measured by the accelerometer 146. Specifically, the data regarding positional changes of the key fob 140 are tracked by the processors and memory (112, 114 and 142,144), the key fob 140, and/or the computing device 110. If the change(s) in position indicate the key fob 140 has been moved outside the field 160 or the movement data is too erratic within the field 160, access to the computing device 110 is terminated. Termination of access can be carried out in many ways. For example, the display adapter 118 and serial ATA controller 119 for the device 110 are disabled automatically, preventing unauthorized access. Disabling various components of a computing device 110 to secure the device 110 may involve switching off the control busses for the various components in addition to or in place of cutting the power to the component, etc.

As mentioned above and schematically shown in FIG. 1, aspects of the systems and methods described herein are controlled by one or more controllers 50. The one or more controllers 50 may be adapted to run a variety of application programs, access and store data, including accessing and storing data in the associated databases and enable one or more interactions as described herein. Typically, the controller 50 is implemented by one or more programmable data processing devices (e.g., a computing 110 and/or key fob 142). The hardware elements, operating systems, and programming languages of such devices are conventional in nature, and it is presumed that those skilled in the art are adequately familiar therewith.

For example, the one or more controllers 50 may be a PC based implementation of a central control processing system utilizing a processor 112, memory 114, and an interconnect bus. The processor 112 may contain a single microprocessor, or it may contain a plurality of microprocessors for configuring the CPU as a multi-processor system. The memory 114 may include a main memory, such as a dynamic random access memory (DRAM) and cache, as well as a read only memory, such as a PROM, EPROM, FLASH-EPROM, or the like. The system may also include any form of volatile or non-volatile memory 114. In operation, the memory 114 stores at least portions of instructions for execution by the processor 112 and data for processing in accord with the executed instructions.

The one or more controllers 50 may also include one or more input/output interfaces for communications with one or more processing systems (e.g., the computing device's communications adapter 116).

The one or more controllers 50 may further include appropriate input/output ports for interconnection (e.g., the display adapter 118) with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller 50. For example, the one or more controllers 50 may include a graphics subsystem and display adapter 118 to drive the output mechanism. The links of the peripherals to the controller 50 may be wired connections or use wireless communications.

Although summarized above as a PC-type implementation, those skilled in the art will recognize that the one or more controllers 50 also encompasses systems such as host computers, servers, workstations, network terminals, and the like. Further one or more controllers 50 may be embodied in a device, such as a mobile electronic device, like a smartphone or tablet computer and even a key fob 140. In fact, the use of the term controller 50 is intended to represent a broad category of components that are well known in the art.

Hence aspects of the systems and methods provided herein encompass hardware and software for controlling the relevant functions. Software may take the form of code or executable instructions for causing a controller 50 or other programmable equipment to perform the relevant steps, where the code or instructions are carried by or otherwise embodied in a medium readable by the controller 50. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 114 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 50 can read programming code and/or data. Many of these forms of computer readable media may be involved in carrying one or more sequences of one or more instructions to a processor for execution.

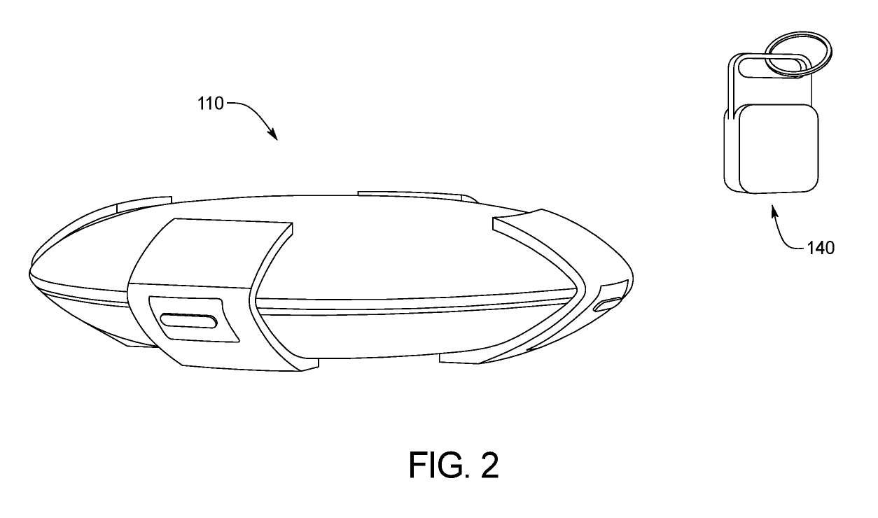

FIG. 2 is a perspective view of components of a proximity protected keyless security system 100. The components shown in FIG. 2 are a computing device 110 and key fob 140. The computing device 110 is designed in such a way to prevent physical unauthorized access (e.g., no USB ports, etc.) and is secured via the proximity protected keyless security system 100. The computing device 110 will not function unless the key fob 140 is within an acceptable distance from the device 110 and remains in this range for the duration of secure access.

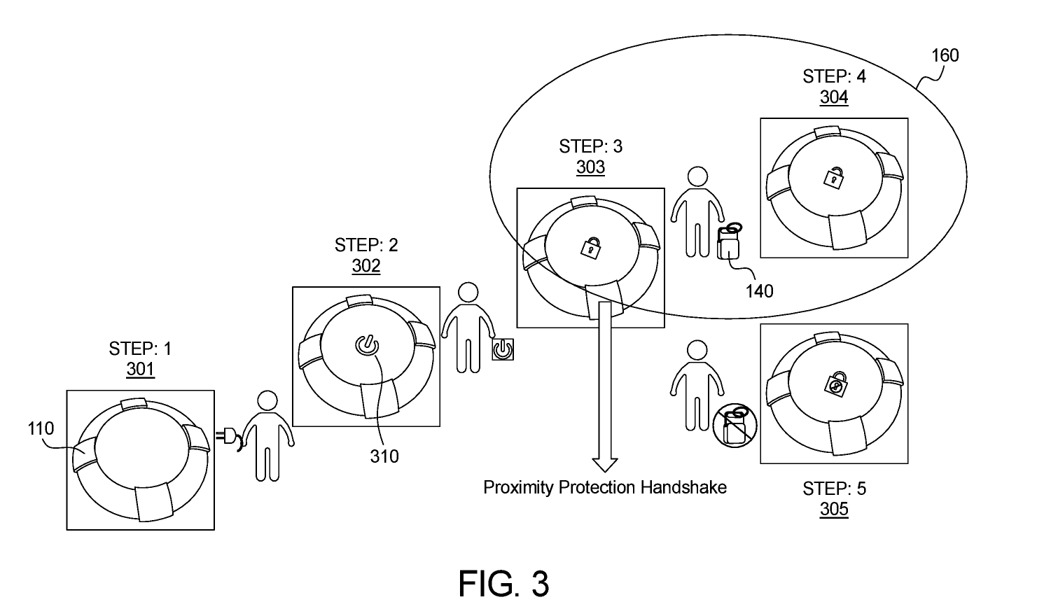

FIG. 3 is a stepwise illustration of how a proximity protected keyless security system 100 can secure a computing device 110. As shown in FIG. 3, at a first step 301 the computing device 110 can be unplugged and powered off (and data on the device is inaccessible due to the device's 110 other security measures mentioned). Once the device 110 is plugged in (at a second step 302) and powered on (at a third step 303) a secure sub-system on the computing device 110 can be powered up while the rest of the computing device 110 remains powered off. A secure sub-system can operate to detect the presence of the key fob 140, while keeping no secured information on the sub-system. The security status of the device 110 can be indicated by a status indicator 310. A lock symbol displayed by the status indication 310 at the third step 303 serves as a visual indication that the key fob 140 is not yet within the proximity field 160. Once the key fob 140 is brought within range of the device 110, the sub-system detects it and activates the rest of the computing device's 110 components (e.g., the main hard disk drive(s), monitor, network connection, etc.). The sub-system can wirelessly communicate with the key fob 140 via secure NFC communication initially. Post key fob 140 authentication a smart Bluetooth connection can be used to determine the key fob's 140 continued proximity to the device 140. The device 110 can also indicate secure access has been granted via status indicator 310, which shows an unlocked lock at a fourth step 304.

Key fob 140 authentication (mentioned above) can operate as follows: during authentication, key fob 140 authenticity can be first established over secure NFC communication. Post-NFC authentication, a separate, second authentication can occur between the sub-system of the computing device 110 and key fob 140 via a different wireless communication protocol (e.g., Bluetooth). During the second authentication, an authentication algorithm can be utilized by the system 100. Such an algorithm can feature a pseudo random number generator which generates random numbers used for authentication. The random numbers generated by the pseudo random number generator can also have an associated expiration date (also known as a time-to-live token) and a pseudo random number generator seed increment count assigned to them by the authentication algorithm. The random number set generated may be actively disabled by the system 100 in addition to the expiration time-to-live discussed above, depending on the situation. Additionally, an initial proximity measurement between the device 110 and key fob 140 is transmitted through the secure NFC channel.

After initial key fob 140 authentication, the key fob's 140 Bluetooth transmitter (which is part of the communication adapter 148 discussed in FIG. 1) begins broadcasting authentication data generated using the authentication algorithm. The computing device 110 monitors the authentication data generated by authentication algorithm running on the key fob 140 over time to ensure the authentication is still valid, with a distance measurement algorithm running on the key fob 140 estimating how far the key fob 140 has travelled from its original location (e.g., the initial proximity measurement) and also how far it is from the computing device.

When the distance travelled by the key fob 140 crosses the proximity field 160, the distance measurement algorithm switches off the Bluetooth broadcast coming from the key fob 140. With the Bluetooth broadcast ended, the computing device will re-enter its secured state (a fifth step 305) with the status indicator 310 indicating such a change. It should be noted that the authentication and transmission of data mentioned above is just one manner in which the system 100 may function. Any of the above data points may or may not be transmitted by the system 100 as needed depending on the system's 100 application and the data points above may be substituted for other data points as needed.

It should be noted that in the secured state, many different actions can be carried out by the computing device 110 to secure itself. Such actions can include cutting off hard disk drive access, turning off the monitor (shown in FIG. 1), disabling component control busses (e.g., HDMI, USB, etc.), and can also include logging a user out of the device 110 or blocking access to certain applications. In more extreme cases, the system 100 can be setup to send alerts when access to the system is terminated (e.g., key fob 140 is taken out of range) or to erase sensitive files off the device 110. This system 100 can also be adapted to secure vehicles, offices, homes, and prevent cheating in video games.

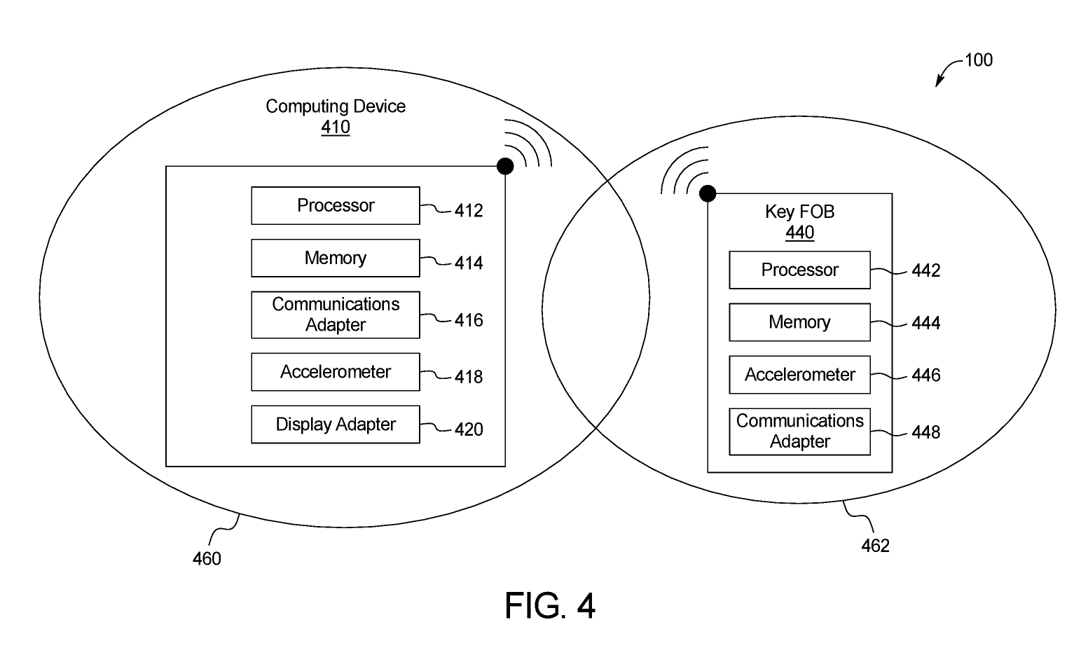

FIG. 4 is an overview diagram of an example of a proximity protected keyless security system 100 wherein two system 100 components utilize an accelerometer (a computing device accelerometer 418 and key fob accelerometer 446). As shown in FIG. 4, the system 100 features a computing device 410 and key fob 440. The computing device 440 can feature a processor 412, memory 414, communications adapter 416, computing device accelerometer 418, and display adapter 420. The processor 412 and memory 414 of the computing device 410 operate, at least in part, to monitor and receive movement data from the key fob 440 via the communications adapter 420. The processor 412 and memory 414 of the computing device 410 also monitor and transmit movement data captured by the computing device's 410 own computing device accelerometer 418 regarding movement of the device 410. The computing device's accelerometer 418 data regarding the movement of the device 410 is used in conjunction with data collected by the key fob's 440 accelerometer 446 by the system 100 to determine relative movement between the key fob 440 and device 410. The key fob 140 can contain a processor 442, memory 444, and communications adapter 448 to track and communicate the needed movement data.

Movement of the two components (the computing device 410 and key fob 440) is tracked by the system 100 on the computing device 410 and/or key fob 440 with a pre-defined proximity field being set for both the computing device 410 and key fob 440 (the proximity fields being computing device's proximity field 460 and key fob's proximity field 462, respectively). The proximity fields (460 and 462) are defined by the proximity between which the computing device 410 and key fob 440 must be within for the system 100 to remain unlocked and accessible. If the computing device 410 and/or key fob 440 are moved out of each other's proximity fields (460 and 462), in this embodiment, the computing device's 410 display adapter 420 (e.g., an HDMI control bus, etc.) will be disabled by the system 100; preventing use of the device 410 by a user.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system comprising:
a controller;
a memory coupled to the controller, wherein the memory is configured to store program instructions executable by the controller;
wherein in response to executing the program instructions, the controller is configured to:
receive a first acceleration data from a key fob, wherein the key fob is configured to generate an unlocking code for accessing a computer console, wherein the key fob includes a key fob accelerometer;
receive a second acceleration data from the key fob, wherein the second acceleration data is received after a predetermined time from the receipt of the first acceleration data; and
determine a distance traveled by the key fob between the time from receiving the first acceleration data and the time from receiving the second acceleration data, wherein if the first distance is greater than a predetermined distance, the controller is configured to disable access to the computer console.

2. The system of claim 1 wherein if the first distance is less than a predetermined distance, the controller is configured to automatically provide access to the computer console.

3. The system of claim 1 wherein the computer console includes a computer accelerometer, wherein the controller is configured to determine a second distance between the computer console and the key fob based on data received from the computer accelerometer and the key fob accelerometer, wherein if the second distance is greater than a predetermined distance, the controller is configured to disable access to the computer console.

4. The system of claim 3 wherein if the second distance is less than a predetermined distance, the controller is configured to automatically provide access to the computer console.

5. The system of claim 1 wherein the computer console is a desktop computer.

6. The system of claim 1 wherein the computer console is a mobile computing device.

7. The system of claim 1 wherein the predetermined distance is ten feet.

8. The system of claim 3 wherein the second distance is ten feet.

9. The system of claim 1 wherein system access is disabled by deactivating a component of the computer console.

10. The system of claim 9 where the component of the computer console is deactivated via a control bus.

11. A method comprising:
receiving a first acceleration data from a key fob, wherein the key fob is configured to generate an unlocking code for accessing a computer console, wherein the key fob includes a key fob accelerometer;
receiving a second acceleration data from the key fob, wherein the second acceleration data is received after a predetermined time from the receipt of the first acceleration data; and
determining a distance traveled by the key fob between the time from receiving the first acceleration data and the time from receiving the second acceleration data, wherein if the first distance is greater than a predetermined distance, the controller is configured to disable access to the computer console.

12. The method of claim 11 wherein if the first distance is less than a predetermined distance, the controller is configured to automatically provide access to the computer console.

13. The method of claim 11 wherein the computer console includes a computer accelerometer, wherein the controller is configured to determine a second distance between the computer console and the key fob based on data received from the computer accelerometer and the key fob accelerometer, wherein if the second distance is greater than a predetermined distance, the controller is configured to disable access to the computer console.

14. The method of claim 13 wherein if the second distance is less than a predetermined distance, the controller is configured to automatically provide access to the computer console.

15. The method of claim 11 wherein the computer console is a desktop computer.

16. The method of claim 11 wherein the computer console is a mobile computing device.

17. The method of claim 11 wherein the predetermined distance is ten feet.

18. The method of claim 13 wherein the second distance is ten feet.

19. The method of claim 11 wherein system access is disabled by deactivating a component of the computer console.

20. The method of claim 19 where the component of the computer console is deactivated via a control bus.
